(19) United States
(12) Patent Application Publication
(10) Pub. No.: US 2004/0124193 A1
(43) Pub. Date: Jul. 1, 2004

(54) Fluid storage apparatus

(76) Inventor: Charles Buchan Ritchie, Peterhead (GB)

Correspondence Address: Robert E. Cannuscio, DRINKER BIDDLE & REATH LLP, One Logan Square, 18th & Cherry Streets, Philadelphia, PA, 19103-6996, US

(21) Appl. No.: 10/727,713

(22) Filed: Dec. 4, 2003

(30) Foreign Application Priority Data
Dec. 4, 2002 (GB) 0228282.0

(51) Int. Cl. B01L 3/00; G01N 1/14; B65D 83/76

(52) U.S. Cl. 220/23.86; 73/864.62; 73/864.91; 220/502

(57) ABSTRACT

An apparatus for the storage of cellular fluids. The apparatus comprises a first chamber capable of containing a sample of cellular fluid, and a second container which is adapted to receive fluid from the first container. The second container also comprises a bored piston which, when inserted into the first chamber, forces the cellular fluid through the bore and into the second chamber. As the first and second containers are brought together, the piston and the first chamber seal together to create a sealed volume. Also, as the cellular fluid is pressurised through the bored piston into the second chamber the cells of the fluid burst, leaving a disrupted sample which is safe from contamination or degradation.

### TECHNICAL FIELD

The present invention relates to fluid storage apparatus, in particular, but not exclusively, to apparatus for the disruption and storage of cellular fluids.

### BACKGROUND

A knowledge of the constituent components of the cells of cellular fluids, such as deoxyribonucleic acid, are of great importance to the understanding of how such cells function. In order to analyse these components from the cells it is necessary to cause disruption of the cells. This basically means that the walls of the cells are broken down, thus allowing the constituent components to be removed for analysis.

Disrupted cellular fluids, that is, cellular fluids in which the cell walls have burst, are conventionally stored in a pre-sterilised sealed container which may be further stored in a plastic bag and refrigerated prior to use. Storing disrupted cellular fluids in this manner however, means taking a sample of the disrupted cellular fluid and placing it in the container. This handling of the sample greatly increases the risk of contamination and degradation of the sample. Furthermore, the container used to store the sample is often sterilised for re-use, which is expensive and further increases the risk of contamination and degradation of the sample.

It is an object of the present invention to provide a fluid apparatus for the disruption and storage of cellular fluids which obviates or mitigates one or more of the disadvantages referred to above.

### SUMMARY OF INVENTION

According to a first aspect of the present invention there is provided a fluid storage apparatus comprising a first container having a first chamber capable of being filled with a fluid, a second container having a second chamber adapted to receive fluid from said first chamber, the second container having a piston means slideably receivable within said first chamber of said first container, wherein, on insertion of said piston means into said first chamber of said first container, fluid is displaced from said first chamber to said second chamber.

Preferably the piston means and the second container are integrally formed.

Preferably the piston means has a bore which fluidly communicates with the first and second chambers.

Preferably the bore has a first portion having a first diameter, and a second portion having a second diameter which is smaller than the first diameter.

Preferably the first portion of the bore is adjacent the second chamber and the second portion of the bore is remote from the second chamber.

Preferably the fluid storage apparatus further comprises a sealing means adapted to seal the first and second containers together.

Preferably the first and second containers are adapted to seal together as the fluid is displaced to the second chamber.

Preferably at least one portion of the second chamber is adapted to allow fluid to be removed therefrom.

Preferably the fluid storage apparatus further includes cutting means adapted to remove a part of the apparatus such that the stored fluid may be removed from the second chamber.

Preferably the fluid storage apparatus is disposable.

### BRIEF DESCRIPTION OF THE DRAWINGS

Embodiments of the present invention will now be described, by way of example only, with reference to the accompanying drawings, in which:-

FIG. 1 is a side view of a first embodiment of a fluid storage apparatus in an initial position,

FIG. 2 is a side view of the fluid storage apparatus of FIG. 1 in a storage position,

FIG. 3 is a side view of a second embodiment of a fluid storage apparatus in an initial position, and

FIG. 4 is a side view of the fluid storage apparatus of FIG. 3 in a storage position.

### DETAILED DESCRIPTION

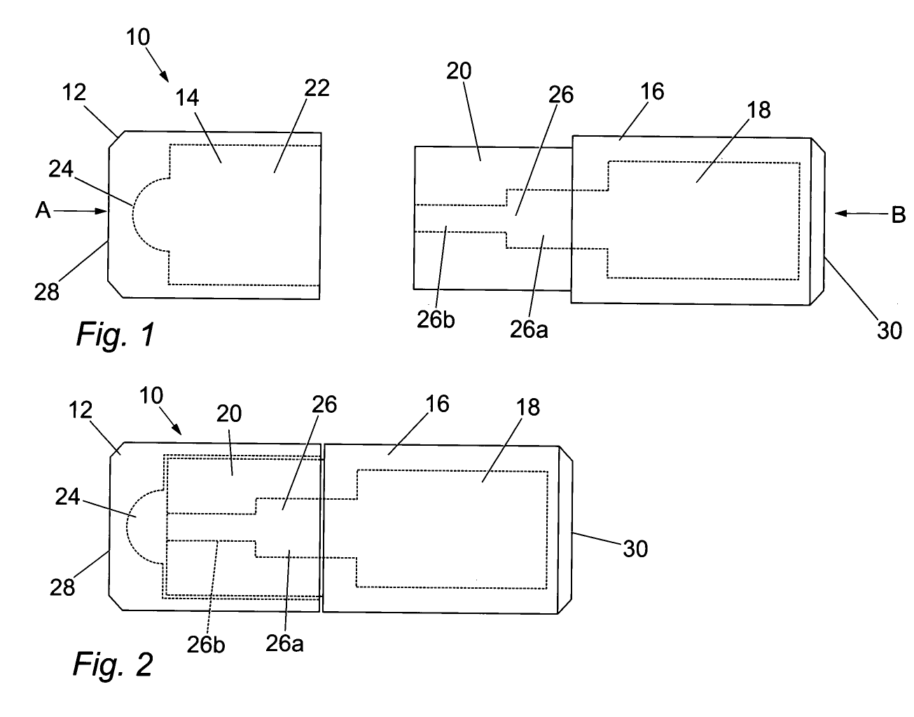

Referring to FIGS. 1 and 2 of the drawings, a fluid storage apparatus 10 comprises a first container 12 having a first chamber 14 capable of being filled with a volume of cellular fluid, and a second container 16 having a second chamber 18 and a piston 20. A cellular fluid is considered here as being a fluid which is comprised of a large number of cells. For example biological or man-made materials, such as blood, tissue homogenate and saliva.

The piston 20 and the second container 16 are integrally formed.

The piston 20 has a central bore 26 which allows fluid communication between the first and second chambers 14 and 18 when in use.

The first container 12 is substantially cylindrical and defines the first chamber 14, which has a first portion 22 which is also substantially cylindrical, and a second portion 24 located adjacent the first portion 22 which is semi-spherical.

The second container 16 is again substantially cylindrical and defines the second chamber 18 which is also substantially cylindrical. The second chamber 18 is adapted to store the cellular fluid when the apparatus 10 is in use.

The second container 16 also comprises a piston 20 which extends in a longitudinal direction from the second chamber 18. The piston 20 has a central bore 26. The bore 26 has a first portion 26a adjacent the second chamber 18 and a second portion 26b remote from the second chamber 18. The first portion 26a has a first diameter and the second portion 26b has a second diameter which is smaller than the first diameter. The piston 20 is slidably engageable with the first portion 22 of the first container 12. The piston 20 and the first portion 22 are sized such that, when they are engaged with one another, a seal is formed therebetween by virtue an interference fit created between the side of the piston 20 and the side of the first chamber 14. An interference fit is considered here as meaning a fixed connection between two components which arises by virtue of friction between the two components. Thus, once the piston 20 is at least partially inserted in the first chamber 14, the first chamber 14, the second chamber 18 and the central bore 26 define a sealed volume, which prevents the surrounding air from contaminating or degrading the fluid in the apparatus 10.

The second chamber 18 may have a portion (not shown) which is adapted to allow fluid to be removed therefrom. For example, the second chamber 18 may have a thinner wall portion which would allow the insertion of a syringe for extraction of the fluid.

The typical volume of sample contained within the fluid storage apparatus 10 is approximately 5 ml, although other volumes may be used.

Prior to use the first and second containers 12 and 16 are sterilised.

In operation, the first chamber 14 of the first container 12 is filled with a sample of cellular fluid. The piston 20 is then inserted into the first portion 22 of the first chamber 14 and the first and second containers 12 and 16 are then urged together by means of applying longitudinal forces A and B to their respective end portions 28 and 30.

The first and second containers 12 and 16 are brought together by a machine (not shown) which applies the requisite amount of force to the end portions 28 and 30.

As the first and second containers 12 and 16 are brought together the cellular fluid contained in the first chamber 14 is forced by the piston 20 through the central bore 26 and into the second chamber 18. Due to the sealing fit of the piston 20 and the first chamber 14, no fluid can escape between the piston 20 and the first chamber 14.

The longitudinal forces A and B are applied to the end portions 28 and 30 of the first and second containers 12 and 16 until all the cellular fluid has been transferred from the first chamber 14 to the second chamber 18. Typically, the first and second containers 12 and 16 are brought together in less than 1 millisecond.

The process of bringing the first and second containers 12 and 16 together in the manner described above causes the cells of the cellular fluid to be disrupted. By forcing the piston 20 into the first portion 22 of the first chamber 14, the cellular fluid contained within the first chamber 14 is pressurised and is forced through the central bore 26 and into the second chamber 18. The pressure required to disrupt the cellular fluid is dependent upon the type of cellular fluid, but a typical pressure is in the region of 40 kpsi (276 MPa).

The differing diameters of the first and second portions 26a and 26b of the central bore 26 of the piston 20 creates a step which aids in the disruption of the cellular fluid.

The shape, size and configuration of the central bore 26 may also be varied depending on the type of cellular fluid which is being stored.

The cells in the cellular fluid are disrupted by the following mechanisms: (a) the boundary level cells rupture due to the friction created at the wall of the central bore 26 as the fluid passes through the central bore 26, (b) the cell walls burst due to the pressurisation of the fluid through the central bore 26, (c) the cells explode as they enter the second chamber 18 due to the decrease in pressure and (d) the outer cells burst on impact against the inner wall of the end portion 30 of the second container 16.

Once the first and second containers 12 and 16 have been brought together under the great pressure applied, a seal is formed between the piston 20 and the first portion 22 of the first chamber 14 by virtue of the interference fit described above. This seal allows the disrupted cellular fluid sample to be stored safely and prevents degradation or contamination of the sample.

When the disrupted cellular fluid is to be analysed, a syringe, or the like, is inserted through adapted wall portion (not shown) and the fluid is removed. Alternatively, the fluid storage apparatus 10 may further include a cutting means (not shown) which may be used to simply cut open the apparatus 10, thus allowing the fluid to be removed. The fluid storage apparatus 10 is then disposed of, thus avoiding the need for re-sterilisation.

The preferred material of construction of the fluid storage apparatus 10 is plastic. The first and second container 12 and 16 can be formed by any suitable means, such as injection moulding, for example. The second container 16 and the piston 20 are preferably moulded as one piece.

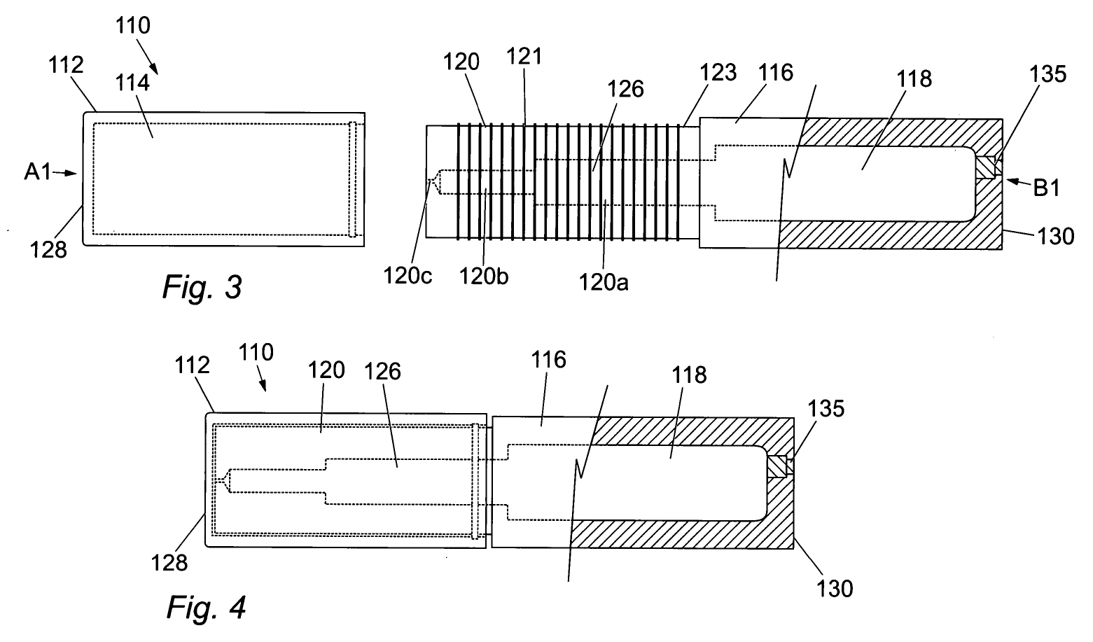

FIGS. 3 and 4 of the drawings illustrate a second embodiment of the present invention. Corresponding similar features between the first embodiment and the second embodiment have not been described, although the same reference numerals have been used, prefixed by the number 1.

The second container 116 also comprises a piston 120 which extends in a longitudinal direction from the second chamber 118. The piston 120 has a central bore 126. The bore 126 has a first portion 126a adjacent the second chamber 118 and a second portion 126b remote from the second chamber 118. The piston 120 also has an orifice 126c at a far end of the piston 120.

The first portion 126a has a first diameter and the second portion 126b has a second diameter. The first diameter is larger than the second diameter.

The piston 120 is slidably engageable with the first portion 122 of the first container 112. The piston 120 has ridged sections 121 along its outer surface 123. The piston 120 and the first portion 122 are sized such that, when they are engaged with one another, a seal is formed therebetween by virtue an interference fit created between the ridged sections 121 of the piston 120 and the side of the first chamber 114.

The fluid storage apparatus 110 is operated in the same manner as in the first embodiment.

When the disrupted cellular fluid is to be analysed, the fluid may be removed from the apparatus 110 by inserting a syringe into a syringe needle access point 135 located adjacent the first chamber 114.

The fluid storage apparatus 10, 110 therefore obviates or mitigates the disadvantages of previous proposals by providing a fluid storage device which allows the cellular fluid sample to be disrupted as part of the sealing of the apparatus. The apparatus both disrupts the cells of the fluid and stores the fluid, thereby obviating the need for separate disruption and storage. The fluid storage apparatus 10, 110 therefore avoids any contamination or degradation of the cellular sample that conventionally arises from the handling of a pre-disturbed sample. Since the fluid storage apparatus 10, 110 is disposable, it also avoids the need for sterilisation after use, which is expensive and further increases contamination and degradation.

The fluid storage apparatus 10, 110 may, for example, be used is the following procedures: cell disruption, cell rupture, homogenisation, French Press principle, single cell isolation, particle size distribution, emulsifying and cell dispersion of micro-organisms, human and animal tissues organs and fluids, plant and soil. The fluid storage apparatus 10, 110 may also be used, for example, in the following applications: release, extraction and isolation of intracellular organelles and including cytoplasmic and membrane proteins and enzymes, inclusion bodies and isolation, shearing and splicing of deoxyribonucleic acids; and diagnosis of microbial based diseases whereby one of the above procedures is required.

Modifications and improvements may be made to the above without departing from the scope of the present invention. For example, although the fluid storage apparatus 10, 110 is described as being used with a cellular fluid, it should be appreciated that the fluid storage apparatus 10, 110 could be used with any biological or man-made material. Also, although the central bore 26, 126 is shown to be made up of stepped diameter sections 26a, 26b, 126a, 126b and 126c, it should be appreciated that the central bore 26, 126 could be shaped in an alternative arrangement. For example the bore could be shaped to form a venturi section. Furthermore, although the disruption of the cellular fluid is described above as occurring from the pressurising of the fluid through a single central bore 26, 126, it should be appreciated that the disruption of the cellular fluid could occur by any type of orifice, or orifices. Also, although the typical volume of cellular fluid sample contained within the fluid storage apparatus is described above as being 5 ml, it should be appreciated that the fluid storage apparatus 10, 110 could be adapted to contain any volume of sample. Furthermore, although the fluid storage apparatus 10, 110 is described above as being constructed from plastic, it should be appreciated that the fluid storage apparatus 10, 110 could be made from alternative materials, including metals such as steel or copper. Also, although the sealing of the fluid storage apparatus 10, 110 is described above as the result of an interference fit between the first portion 22, 122 of the first chamber 14, 114 and the piston 20, 120, it should be appreciated that the fluid storage apparatus 10, 110 could be sealed by any suitable mechanical means. For example, the apparatus 10, 110 could be sealed by clamping the first and second containers 12, 112, 16, 116 together.

Furthermore, although the removal of the sample from the fluid storage apparatus 10, 110 has been described above as by means of access through a portion of the second chamber 18, 118, it should be appreciated that the sample could be removed from the apparatus 10, 110 by providing a sealed screw cap or a bayonet cap or the like at the end portion 30, 130 of the second container 16, 116.

Alternatively, the sample could be removed from the apparatus 10, 110 by providing a frangible diaphragm or the like on a wall of the second container 16, 116 that allows access to the sample once pierced. Also, the sample could be removed from the apparatus 10, 110 by providing a hinged cap (flip-lid) or the like on the second container 16, 116 that could be swung open to allow access to the sample. The sample could also be removed from the apparatus 10, 110 by providing on the second container 16, 116 a plug or the like which could be pierced by a syringe or the like. The sample could also be removed from the apparatus 10, 110 by providing on the second container 16, 116 a check valve which comprises a sealing ball or the like which may be dislodged by a syringe or the like when the sample is removed. The sample could also be removed from the apparatus 10, 110 by providing on the second container 16, 116 a weak portion which may be pierced by a syringe or the like. The sample could also be removed from the apparatus 10, 110 by providing on the second container 16, 116 weak sections formed by grooves on the body of the second container 16, 116 (either internal or external) or the like which may be ‘popped’ or ‘snapped’ out of place allow access to the sample. The sample could also be removed from the apparatus 10, 110 by providing on the second container 16, 116 a breakable spigot or the like on the body of the second container 16, 116 which may be ‘snapped’ off to allow access to the sample. The sample could also be removed from the apparatus 10, 110 by providing on then end portion of the piston 20, 120 a breakable nozzle or the like which may be ‘snapped’ off to allow access to the sample. The sample could also be removed from the apparatus 10, 110 by providing a drain device or the like which may be inserted into the end portion 30, 130 of the is second container 16, 116. The sample could also be removed from the apparatus 10, 110 by providing on the second container 16, 116 an external tear-off strip or the like which may, for example, be formed around the circumference of the second container 16, 116. The external strip is then torn around the circumference of the second container to allow access to the sample. Alternatively, the tear-off strip may be torn by a relative twisting motion between the strip and the container 16, 116. Also, the tear-off strip may be torn-off by providing a key device or the like which links with the tear-off strip allowing the strip to be removed upon a turning action of the key. The external tear-off strip may also include a sealing member provide between the strip and the container 16, 116.

The sample could also be removed from the apparatus 10, 110 by providing on the second container 16, 116 a spin weld weak point or the like which allows a portion of the container 16, 116 to be pulled or twisted off. The sample could also be removed from the apparatus 10, 110 by providing on the second container 16, 116 a ‘ring-pull’ device or the like. The sample could also be removed from the apparatus 10, 110 by providing on the second container 16, 116 a serrated cap portion or the like which is press-fitted onto the end portion 30, 130 of the container 16, 116. The serrated cap portion is simply pulled off when accessing the sample. The sample could also be removed from the apparatus 10, 110 by providing on the second container 16, 116 a sliding gate portion or the like which is simply slid into an ‘open’ position when accessing the sample. The sample could also be removed from the apparatus 10, 110 by providing on the second container 16, 116 a cap portion which may be pulled or slid into an ‘open’ position when accessing the sample. The sample could also be removed from the apparatus 10, 110 by providing on the second container 16, 116 a rotating cap portion which allows one or more fluid extraction points to be aligned with the second chamber 18, 118 of the container 16, 116 when accessing the sample.

Although various methods have been described above for the removal of the sample from the apparatus 10, 11 for analysis, it should be appreciated that the sample may not necessarily need to be removed from the apparatus 10, 110 in order for the sample to be analysed. The apparatus 10, 110 may be constructed of a material which is suitable for the sample to be analysed whilst it is inside the second container 16, 116.

Finally, although the first and second containers 12, 112 and 16, 116 have been described above as being brought together by a machine which applies the requisite force to end portions 28, 128 and 30, 130, it should be appreciated that the first and second containers 12, 112 and 16, 116 could be brought together by any other suitable method.

1. A fluid storage apparatus comprising
a first container having a first chamber capable of being filled with a fluid,
a second container having a second chamber adapted to receive fluid from said first chamber, the second container having a piston means slideably receivable within said first chamber of said first container, wherein, on insertion of said piston means into said first chamber of said first container, fluid is displaced from said first chamber to said second chamber.

2. A fluid storage apparatus as claimed in claim 1, wherein said piston means and said second container are integrally formed.

3. A fluid storage apparatus as claimed in claim 1, wherein said piston means has a bore which fluidly communicates with said first and second chambers.

4. A fluid storage apparatus as claimed in claim 3, said bore has a first portion having a first diameter, and a second portion having a second diameter which is smaller than said first diameter.

5. A fluid storage apparatus as claimed in claim 4, wherein said first portion is adjacent said second chamber and said second portion is remote from said second chamber.

6. A fluid storage apparatus as claimed in claim 1, further comprising a sealing means adapted to seal said first and second containers together.

7. A fluid storage apparatus as claimed in claim 1, wherein said first and second containers are adapted to seal together as the fluid is displaced to said second chamber.

8. A fluid storage apparatus as claimed in claim 1, wherein at least one portion of said second chamber is adapted to allow fluid to be removed therefrom.

9. A fluid storage apparatus as claimed in claim 1, further comprising cutting means adapted to remove a part of said apparatus such that the stored fluid may be removed from said second chamber.

10. A fluid storage apparatus as claimed in claim 1, wherein said fluid storage apparatus is disposable.
